(19) United States
(12) Patent Application Publication
(10) Pub. No.: US 2004/0039705 A1
(43) Pub. Date: Feb. 26, 2004

(54) Distributing a software product activation key

(75) Inventors: Mark Svancarek, Redmond, WA (US); Sunil Swami, Sammamish, WA (US); Sean Afshin Emam, Woodinville, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/326,743

(22) Filed: Dec. 20, 2002

Related U.S. Application Data
(60) Provisional application No. 60/406,073, filed on Aug. 26, 2002.

(51) Int. Cl. G06F 17/60

(52) U.S. Cl. 705/51

(57) ABSTRACT

A portal obtains information from a customer for providing a product key for activating a product to such customer. The obtained information identifies the product for which the product key is required. The portal sends the obtained information to an eligibility service which determines whether the customer is eligible to obtain the product key. If so, the eligibility service determines and identifies to the portal a type of product key to be provided to the customer. The portal redirects the customer to a distributor to obtain the identified type of product key, where the redirection includes the identified type of product key to be provided to the customer. The distributor conducts an online transaction with the customer to provide the identified type of product key thereto.

### CROSS-REFERENCE TO RELATED APPLICATION

This application claims the benefit of U.S. Provisional Application No. 60/406,073, filed Aug. 26, 2002 under attorney docket number ‘301863.1’ and entitled “System and Method for Distribution of Software”, hereby incorporated by reference in its entirety.

### TECHNICAL FIELD

The present invention relates to a system and method for distributing a key for enabling activation of a software product on a computing device. More particularly, the present invention relates to distributing a software product activation key in an electronic manner.

### BACKGROUND OF THE INVENTION

Product activation key distribution is an extension of a product activation process that enforces a license granted in connection with the acquisition of a software product. Briefly, in the product activation process, and referring now to FIG. 1, a customer acquiring a software product 16 is provided with a product activation key 14 corresponding thereto, which is a unique serial number and product identifier that acts as a proof of purchase or the like. The provided product key 14 is then entered during installation of the software product 16 on a particular computer device 18 to act as a proffer that the software product 16 was acquired legally and/or otherwise properly. The product activation key 14 need not be and typically is not cryptographic in nature, although a digital signature (which is cryptographic in nature) may be included to act as a guarantee that the product key 14 is genuine.

The entered product key 14 and an ID representative of the computer device 18 are then sent to a product activation service 100 as part of the installation process. As may be appreciated, the product activation service 100 determines whether the entered product key 14 is valid, whether the product key 14 has been employed before, and if so in connection with what computer device 18. Typically, each product key 14 enables an installation or re-installation of the software product 16 on a single computing device 18, as is set forth in a corresponding license agreement, although a product key may also enable a set number of installations I re-installations on multiple computer devices 18 also.

Accordingly, if the product activation service 100 determines that the entered product key 14 has already been employed to install the software product 16 on another computer device 18 (or has been employed a maximum number of times, for example), such activation service 100 will not allow the installation of the software product 16 on the computer device 18 to proceed, will not allow a complete installation of the software product 16 on the computer device 18, or will not allow the installed software product 16 to be used on the computer device 18. Thus, activation as used herein may entail permission to install the software product 16, permission to perform some level of installation of the software product 16, permission to completely install the software product 16, some level of permission to use the software product 16, or complete permission to use the software product 16.

If the activation service 100 declines to activate the software product 16 for the customer based on an entered product key 14 already being used in connection with another computing device 18, or based on the entered product key 14 not supporting the level of activation desired, the customer must acquire another appropriate product key 14 to install/completely install/use the software product 16 on the computing device 18 in the manner desired. Thus, the product key 14 and the product activation service 100 act to ensure that the software product 16 is not nefariously or wantonly installed/activated/used on multiple computing devices 18, such as may be in violation of any software license agreement associated with the software product 16.

Note that as part of the activation process, the activation service 100 may return a digital license 102 to the computing device 18 on which the software product 16 is associated. Such digital license 102 is tied to the computing device 18 such that the license 102 is not usable with any other computing device 18, and may express a level of activation, as well as license terms such as a period of activation or a number of times the software product 16 may be executed on the computing device 18. In general, such license 102 may express any limitations and/or rights and also may express any policies that should be honored in connection with the execution of the software product 16 on the computing device 18, all as set forth by a developer of the software product 16 or another entity.

Note too that the product activation service 100 in large part includes an activation database 36 that lists each product key 14, whether the product key 14 has been employed to perform an installation, and if so the ID of the computing device 18 for which the product key 14 was employed. Thus, a re-installation of a software product 16 on the originally installed computing device 18 is permitted because the ID of the re-install computing device 18 should match the ID of the original install computing device 18 as set forth in the activation database 36 in connection with the corresponding product key 14. Conversely, an attempt to newly install and activate a software product 16 on a second computing device 18 where the same software product 16 was already installed on a first computing device 18 based on the same product key 14 should fail because the ID of the second computing device 18 should not match the ID of the first computing device 18 as set forth in the activation database 36 in connection with the corresponding product key 14.

Because the usage of each unique product key 14 is secured by the product activation service 100, a customer sometimes discovers that it requires additional product keys 14 to enable additional installations/activations/uses of a software product 16. This could be because the customer has installed the software product 16 onto an additional computing device 18, or it could be that the customer has chosen to install the software product 16 onto multiple computing devices 18 rather than purchasing a multi-machine volume license. It could also be that the customer originally installed using an invalid product key 14 which has been subsequently detected and invalidated by the software product 16 itself or by the product activation service 100. In any case, the customer will not be able to install/activate/use the software product 16 on the computing device 18 until an additional product key 14 has been obtained, typically as a purchase, and then appropriately employed with the product activation service 100.

In the prior art, a customer could obtain/purchase a product key 14 by purchasing a physical instance of the software product 16, such as in a box, with a new product key 14 enclosed therewith. Alternatively, the customer could contact a purchasing center by telephone and purchase and receive such a product key 14 over the telephone. However, no system and method have as yet been devised to allow the customer to obtain/purchase a product key 14 in an automated manner over a network or the like from the developer of the software product 16 or an agent thereof or the like.

Accordingly, a need exists for a system and method that allow the customer to obtain/purchase a product key 14 in an automated manner from the developer of the software product 16 or an agent thereof or the like. In particular, a need exists for such a system and method that allow the customer to obtain/purchase the product key 14 over a network such as the Internet. In addition, a need exists for such a system and method that can be integrated into the product installation and activation experience so that a customer attempting to use an invalid product key 14 during a product installation and activation can immediately be forwarded to a product key distribution service.

### SUMMARY OF THE INVENTION

The aforementioned needs are satisfied at least in part by the present invention in which a method and system provide a product key for activating a digital product/service. In the method and system, a portal obtains information from a customer for the product key, where the customer is coupled to the portal by way of a network. The obtained information regards the product/service for which the product key is required. The portal sends the obtained information to an eligibility service, which determines whether the customer is eligible to obtain/purchase the product key.

If the customer is eligible, the eligibility service notifies the portal of same and determines and identifies to the portal a type of product key to be provided to the customer. The portal redirects the customer to a distributor on the network to obtain/purchase the identified type of product key, where the redirection includes the identified type of product key to be provided to the customer. The distributor conducts an online transaction with the customer to provide the identified type of product key thereto.

To obtain a refund of a purchased product key, such purchased product key is identified to a blocking service which determines based on predetermined rules whether the refund is authorized. If so, the blocking service submitting the product key to a product key distribution database to notify same that the product key is to be canceled, and also submits the product key to an activation database to notify same that the product key is not available to activate the product/service, the activation database having knowledge of the submitted product key refusing to allow any future activation transaction based on such submitted product key.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram showing a customer submitting a product key to a product activation service to activate a software product on a computing device;

FIG. 2 is a block diagram representing a general purpose computer system in which aspects of the present invention and/or portions thereof may be incorporated;

FIGS. 3-5 are flow diagrams showing key steps performed in a customer obtaining a product key from a distributor thereof (FIG. 3), the customer returning the product key to the distributor for a refund (FIG. 4), and the distributor obtaining product keys from a delivery service (FIG. 5) all in accordance with embodiments of the present invention; and

FIG. 6 is a block diagram showing a product key distribution system for allowing a customer to obtain/purchase a product key in accordance with embodiments of the present invention.

### DETAILED DESCRIPTION OF THE INVENTION

Computer Environment

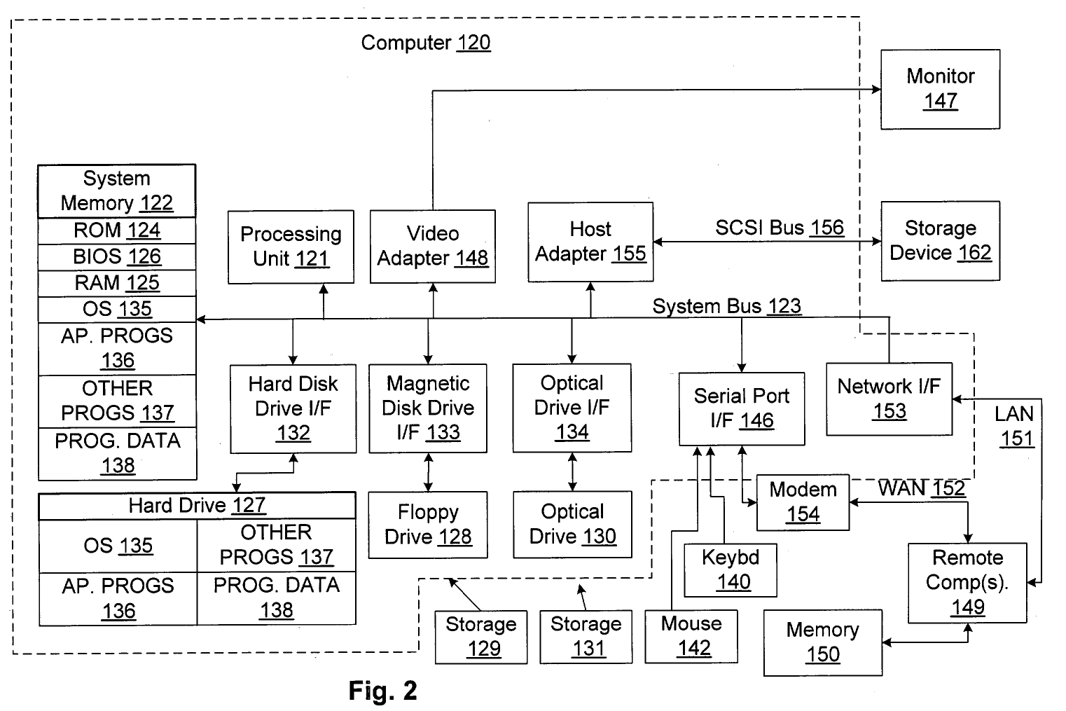

FIG. 2 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 2, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 20.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 2 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 2. The logical connections depicted in FIG. 2 include a local area network (LAN) 151 and a wide area network (WAN) 152. Such networking environments are commonplace in offices, enterprise-wide computer networks, intranets, and the Internet. The personal computer 120 may also act as a host to a guest such as another personal computer 120, a more specialized device such as a portable player or portable data assistant, or the like, whereby the host downloads data to and/or uploads data from the guest, among other things.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

Product Key Distribution System

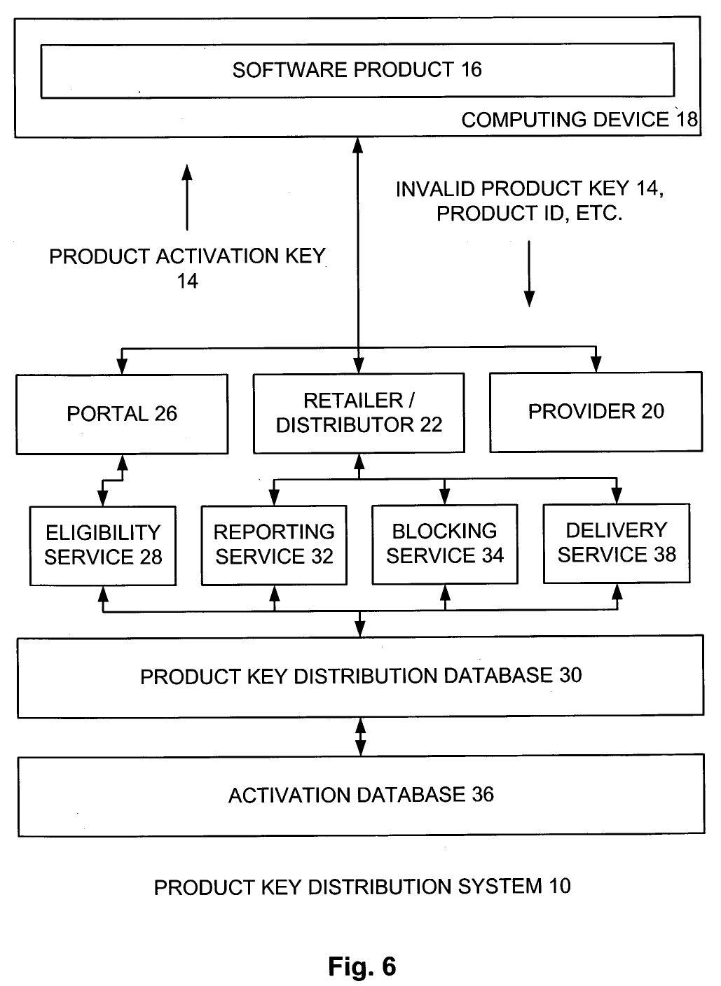

In the present invention, and referring now to FIG. 6, a product key distribution system 10 is accessible to a customer over a network 12 such as the Internet. Accordingly, the customer can obtain from such product key distribution system 10 a valid product key 14 usable to install a corresponding software product 16 on a particular computing device 18. The system 10 may allow the customer to obtain/purchase the product key 14 directly from the provider 20 of the software product 16 or an agent thereof, or from a retailer or other distributor 22 supplied with and authorized to sell the product key 14.

Generally, the product key distribution system 10 provides inventory management of product keys 14 as each key 14 only works on a specific corresponding software product 16. In addition, the system 10 records key consumption and supplies keys 14 to retailers and other distributors 22. The system 10 also provides a secure interface for online retailers and other distributors 22 to request and receive product keys 14 as necessary for online distribution. Finally, the system 10 provides support for returns and cancellations of product keys 14 by integrating with a product key distribution database 30 to prevent a returned/canceled product key 14 from being employed to install and activate the software product 16 corresponding thereto.

In the present invention, a customer can obtain/purchase (hereinafter ‘purchase’) a product key 14 to install and activate a software product 16 on a particular computing device 18 by way of: (1) a user interface (UI) incorporated within the software product 16; or (2) a web site operated by the developer 20 of the software product or an agent thereof, or by a retailer or other authorized distributor 22 or influencer. In the former case, the UI may appear if a product activation fails due to the use of an already-used product key 14, and may inform the customer that an online purchase is possible and that such a purchase may be conducted, regardless of any other functionality restrictions, by way of an appropriate link to a web site. Thus, the UI is useful to a customer that has already attempted to install the software product 14 and has encountered a product activation rejection.

In the latter case, the customer visits a web site to conduct the purchase. Such a web site is useful to a customer that anticipates the need to purchase a product key 14 but has not yet installed the software product 16 or encountered a product activation rejection. Note that an influencer is a party that refers the customer to the portal 26, and may be reimbursed for the referral. Such influencer typically is known to the portal 26 and may send customer information to the portal 26 on behalf of the customer. Such influencer may also be reached by way of the UI.

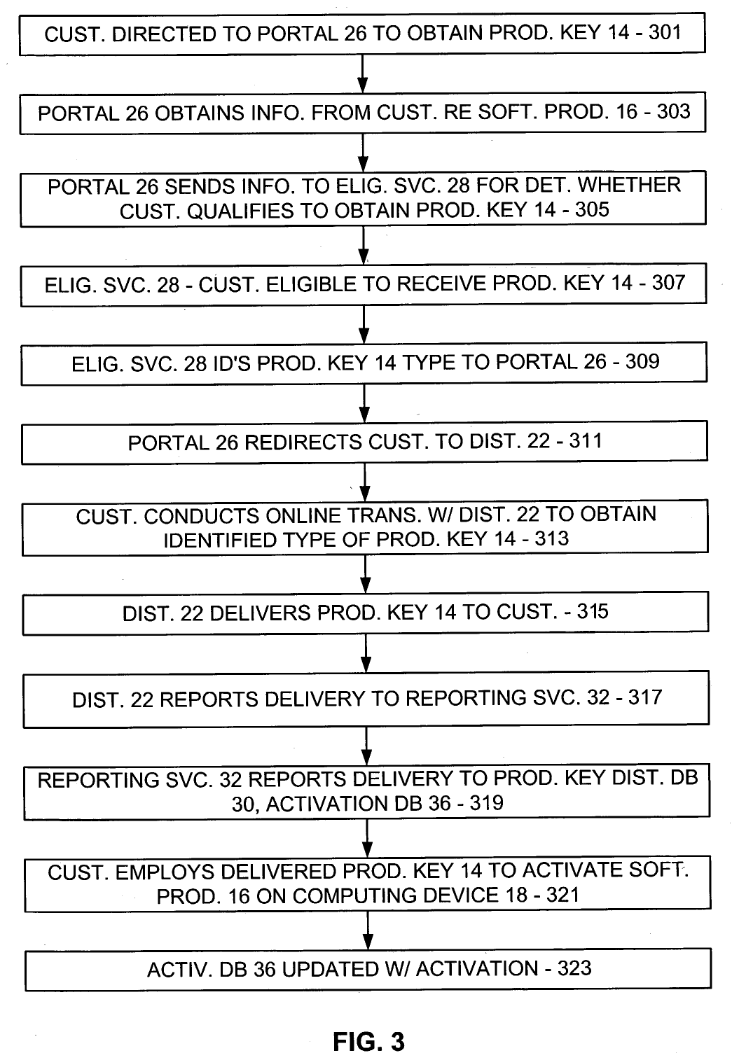

In one embodiment of the present invention, and with reference to FIG. 3 in addition to FIG. 6, whether accessing the system 10 by way of a UI or otherwise, a customer or influencer is first directed to a portal 26 at a web site or the like (step 301). The portal 26 obtains information from the customer regarding the software product 16 for which a product key 14 is required, and may also collect other information, including product activation error information if the portal 26 was reached because of a product activation error, and/or distributor information if the portal 26 was reached through a retailer or other distributor 22 (step 303). The information regarding the software product 16 for which a product key 14 is required may be derived from a previously submitted but invalid product key 14 for the product 16. As may be appreciated, such product key 14 includes therein information that may be employed to identify such product 16. Alternatively, Such information maybe derived from a product ID attached to the product.

Upon collecting all appropriate information, the portal 26 then sends such information to an eligibility service 28 that determines whether the user is qualified to obtain/purchase the desired product key 14 (step 305). The eligibility service 28 may employ most any business logic without departing from the spirit and scope of the present invention. For example, such eligibility service 28 may determine whether the customer is in a participating region and/or has a participating software product 14.

Significantly, in the case where the portal 26 was reached because a product activation attempt failed due to an already-used product key 14, the eligibility service 28 may also determine by reference to a product key distribution database 30 whether the already-used product key 14 has previously resulted in the distribution of a set number of additional product keys 14, such as for example 3-5. In such case, it may be that the customer should be directed elsewhere to obtain a volume license or a multi-machine license. Note that although the portal 26 could encompass the eligibility service 28 without departing from the spirit and scope of the present invention, separating the functionality of the elements 26, 28 allows for increased flexibility in modifying both as need be.

Assuming the eligibility service 28 determines that the customer is eligible to receive a product key 14 for activating the software product 16 at issue (step 307), the eligibility service 28 notifies the portal 26 of same and also determines and identifies to the portal 26 the proper type of product key 14 to be distributed to the customer (step 309). Such proper type may for example be determined based on where the customer is located, what type of channel the software product 16 was originally distributed through, a serial number attached to the software product 14, a version of the software product 14, and any other typing information that is or may be attached to the software product 16 and/or customer. Of course, the eligibility service 28 in typing the portal key 14 to be distributed to the customer may need to be privy to type mapping information available from the provider 20 of the software product 16. As may be appreciated, such typing information is often arbitrary, complex, and based on private anti-piracy information which the provider 20 wishes to maintain as confidential. Accordingly, the eligibility service 28 in such a situation is run by or closely aligned with the provider 20.

At this point, the portal 26 has information on the software product 16 for which a product key 14 is required and the identified proper type of product key 14 to be distributed to the customer. The portal 26 may then redirect the customer to an appropriate location to obtain/purchase the identified type of product key 14 (step 311). Here, the location is a network site such as a web site or the like. Note that the redirection location may be determined by the eligibility service 28, the portal 26, and/or the customer based on the circumstances of the transaction. For example, the eligibility service 28 may determine that the customer should be redirected to a site operated by the provider 20 of the software product 16 or an agent thereof in the case where the identified type of product key 14 is to be provided free of charge. Correspondingly, the eligibility service 28 and/or the portal 26 may determine that the customer should be redirected to any of a number of sites operated by distributors 22 authorized to provide the identified type of product key 14 in the case where the identified type of product key 14 is to be purchased by the customer and where the customer is allowed to opt from among the distributors 22.

The portal 26 includes in the redirection to the site of the provider 20, distributor 22, or otherwise the information needed at such site to obtain and deliver the identified type of product key 14. Accordingly, the customer at the redirection site conducts an online transaction to obtain/purchase the identified type of product key 14 (step 313). For example, the customer may be required to enter a name, an address, and electronic mail address, or the like. In addition, if the transaction involves a purchase, the customer may be required to enter an account number and other related billing information or the like.

In accordance with the transaction being effectuated, the provider 20, distributor 22, or otherwise (hereinafter, ‘distributor 22’) obtains and delivers to the customer a product key 14 of the identified type (step 315). As set forth in more detail below, the distributor 22 may have a supply of the product keys 14 of various types available thereto, and thus obtains the to-be-delivered product key 14 from such supply. As may be appreciated, the product key 14 may be delivered from the distributor 22 to the customer by way of a secure page, an encrypted electronic mail message, and/or the like. In addition, the product key 14 may be delivered directly to a UI of the software product 14 and from there may automatically be employed to activate such software product 14.

Once the transaction is complete, the distributor 22 reports the distribution of the product key 14 to a reporting service 32 (step 317). The reporting service 32 in particular receives information from the distributor 22 regarding the delivered product key 14, associates the delivered product key 14 with the corresponding eligibility determination and approval as performed by the eligibility service 28, and stores appropriate information based thereon in the product key distribution database 30. With such information, the reporting service 32 may for example note that the particular copy of the software product 16 has the distributed product key 14 associated therewith, and can thus track how many product keys 14 have been distributed in connection with such copy. Also, the distributed product key 14 can now be submitted as an input for subsequent purchases of product keys 14 for the software product 16.

The reporting service 32 thus stores in the database 30 a link between any information which was logged at the portal 26, allows the portal 26 to discover such link when determining eligibility at a later time in connection with the copy of the software product 14, allows the provider 20 to track the history of the copy of the software product 16 and the distributed product keys 14 therefor, and also can enforce any predefined business rules. Note, though, that at this point the delivered product key 14 is not associated with any particular computing device 18 inasmuch as such product key 14 has not been employed to activate the corresponding software product 16 on such a computing device 18. Thus, the reporting does not tie the reported product key 14 to any particular computing device 16.

Concomitant with the reporting service 32 reporting the delivery of the product key 14 to the database 30, such delivery is also reported to an activation database 36 by the reporting service 32 or by an intermediary between the databases 30, 36 (step 319). As may be appreciated, the activation database 36 tracks each delivered product key 14 with regard to whether same has already been employed to activate a corresponding software product 16 on a particular computing device 18 and if so pertinent activation information including an ID of such computing device 18. Thus, the activation database 36 having knowledge of the delivered product key 14 and knowledge that such product key 14 is usable to activate the software product 16 on any computing device 18 will allow an activation transaction on a computing device 18 based on such product key 14.

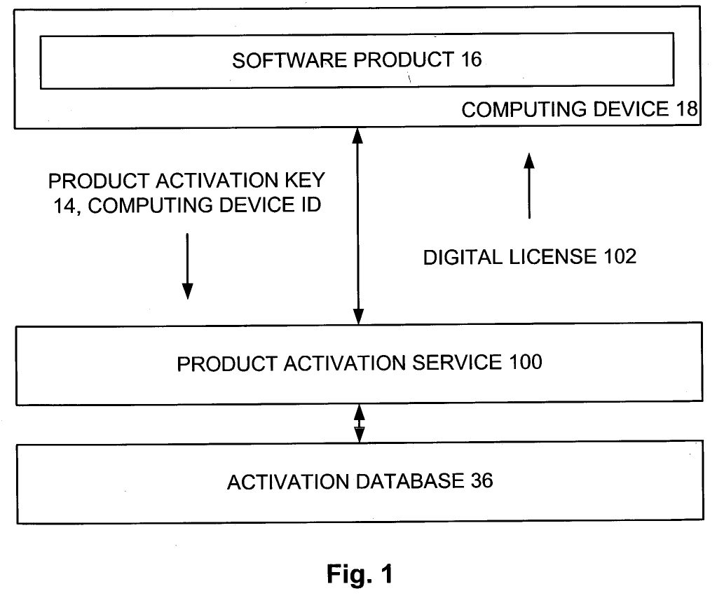

Accordingly, the customer employs the delivered product key 14 to activate the software product 16 on a particular computing device 18 by way of the product activation service 100 of FIG. 1 (step 321), and the activation database 36 is updated to reflect that the product key 14 has in fact been employed to activate the corresponding software product 16 on the particular computing device 18 as represented by the ID thereof (step 323).

Note that it may be the case that a customer approaches a distributor 22 to obtain/purchase a product key 14 without first visiting the portal 26, as at step 301. In such a situation, the distributor 22 may re-direct the customer to the portal 26 and in so doing attach to the redirection a message that the customer is to be redirected back to the particular distributor 22 to in fact consummate the transaction to obtain/purchase the product key 14.

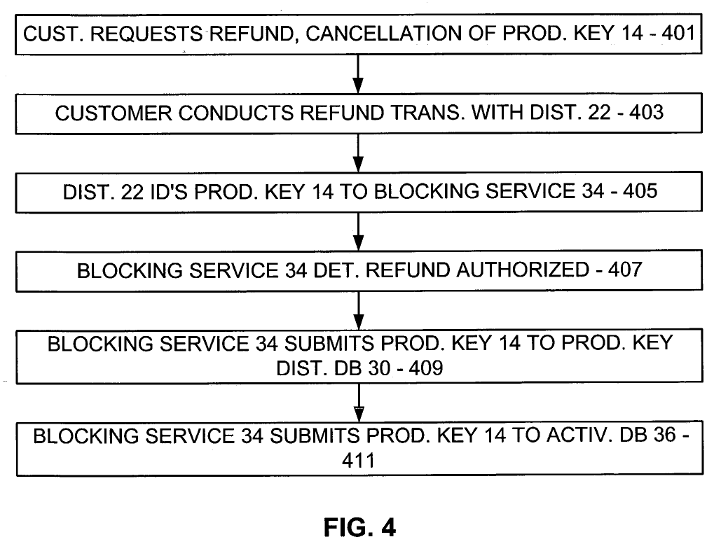

Referring now to FIG. 4 and still to FIG. 6, for whatever reason, the customer may decide to request a refund of a purchase of a distributed product key 14 and the corresponding cancellation of the product key 14 (step 401). That is, the customer may decide that use of the software product 16 is no longer desired, and a refund is therefore requested. If so, the customer contacts the distributor 22 and conducts an appropriate refund transaction therewith, assuming the distributor 22 chooses to honor the request (step 403). In connection with the refund transaction, and in one embodiment of the present invention, the canceled product key 14 is identified to the distributor 22 and such distributor 22 identifies such canceled product key 14 to a refund and blocking service 34 (step 405).

Note that the software provider 20 may impose product-specific refund constraints. For example, the provider 20 may choose to decline a refund if it can be determined that the product key 14 at issue has already been used or has been used for a pre-defined length of time. As with the eligibility service 28, then, the refund and blocking service 34 determines whether the provider 20 authorizes the refund according to any pre-defined business rules, in a manner transparent to and hidden from the distributor 22 (step 407).

Assuming the product key 14 is eligible for a refund, such product key 14 is in fact submitted to the blocking service 34 and the blocking service 34 submits the product key 14 to the product key distribution database 30 (step 409). Thus, further purchases of product keys 14 based on the submitted product key 14 are prevented. In addition, the blocking service 34 submits the product key 14 to the activation database 36 or the database 30 identifies the submitted product key 14 to the database 36, perhaps by way of an appropriate intermediary (step 411). As was disclosed above, the activation database 36 tracks each distributed product key 14 with regard to whether same has already been employed to activate a corresponding software product 16 and if so pertinent activation information. Thus, the activation database 36 having knowledge of the submitted and returned product key 14 will refuse to allow any future activation transaction based on such submitted product key 14.

As should now be appreciated, the blocking service 34 acts as a scrap and return mechanism for business between the distributor 22 and the software provider 20. If for example, the distributor 22 has an inventory of product keys 14 which are obsolete because the corresponding software product 16 is no longer for sale, the distributor 22 would simply scrap such inventory using the refund and blocking service 34, and presumably would obtain an appropriate purchase credit or refund.

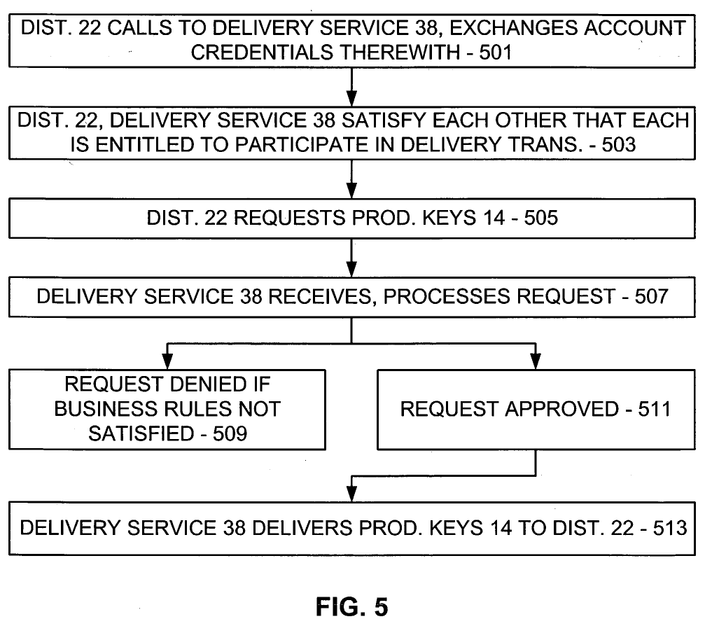

As was set forth above, the distributor 22 is in possession of an inventory of product keys 14 for distribution to eligible customers as determined by the eligibility service 28. Of course, the product keys have to be distributed to the distributor 22. In one embodiment of the present invention, then, and turning now to FIG. 5 as well as FIG. 6, the distributor 22 obtains/purchases the product keys 14 from a delivery service 38. Here, the distributor 22 calls to the delivery service 38 over a secure network channel and exchanges account credentials therewith (step 501). Thus, the distributor 22 and the delivery service 38 satisfy each other that each is entitled to participate in a delivery transaction (step 503). Thereafter, the distributor 22 requests a number of product keys 14 of one or more types (step 505), and the delivery service 38 receives and processes such request (step 507). Presumably, the delivery service 38 can obtain product keys 14 as necessary from the provider 20 or an agent thereof, or can generate the product keys 14 itself.

Note that the delivery service 38 may decide whether to honor the request based on pre-defined business rules, such as for example limits put into place to prevent a nefarious entity from stealing a large number of product keys 14. Accordingly, if a request does not satisfy all business rules in place, such as for example if the number of requested product keys 14 is larger than the limit set in the business rules, the request is denied (step 509). Thus, a security breakdown at the distributor 22 should not easily result in a large theft of product keys 14.

Once the request from the distributor 22 has been processed and approved by the delivery service 38 (step 511), such delivery service 38 in fact delivers the requested product keys 14 to the distributor 22 (step 513), perhaps in the form of a block. The product keys 14 may be encrypted for such delivery, either with a symmetric or asymmetric key. Upon receipt of the delivered product keys 14, the distributor 22 may store each such received product key 14 in an appropriate secure location until the product key 14 is provided to a customer in an online transaction such as that which was described above.

### CONCLUSION

Although the product key 14 has been disclosed herein as being issued for a software product 16, such product key 14 may also be issued for any other item without departing from the spirit and scope of the present invention. For example, the product key 14 may be for activating content, a service, storage space on a network, or the like.

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

In the foregoing description, it can be seen that the present invention comprises a new and useful method and mechanism that allow a customer to obtain/purchase a product key 14 in an automated manner from the developer of the software product 16 or an agent thereof or the like. The system and method allow the customer to obtain/purchase the product key 14 over a network 12 such as the Internet, and can be integrated into the product installation and activation experience so that a customer attempting to use an invalid product key 14 during a product installation and activation can immediately be forwarded to a product key distribution system 10.

It should be appreciated that changes could be made to the embodiments described above without departing from the inventive concepts thereof. It should be understood, therefore, that this invention is not limited to the particular embodiments disclosed, but it is intended to cover modifications within the spirit and scope of the present invention as defined by the appended claims.

1. A method of providing a product key for activating a digital product/service, the method comprising:
a portal obtaining information from a customer for the product key, the customer coupled to the portal by way of a network, the obtained information regarding the product/service for which the product key is required;
the portal sending the obtained information to an eligibility service;
the eligibility service determining whether the customer is eligible to obtain/purchase the product key; and
if the customer is eligible:
the eligibility service notifying the portal of same and determining and identifying to the portal a type of product key to be provided to the customer;
the portal redirecting the customer to a distributor on the network to obtain/purchase the identified type of product key, the redirection including the identified type of product key to be provided to the customer; and
the distributor conducting an online transaction with the customer to provide the identified type of product key thereto.

2. The method of claim 1 comprising the portal obtaining a previously submitted but invalid product key for the product or service, where the invalid product key includes therein information that may be employed to identify such product/service.

3. The method of claim 2 comprising the eligibility service determining by reference to a product key distribution database whether the invalid product key has previously resulted in more than a set number of additional product keys being distributed, and if so determining that the customer is not eligible.

4. The method of claim 1 comprising the portal obtaining an ID of the product or service.

5. The method of claim 1 comprising the eligibility service determining whether the customer has a participating product/service.

6. The method of claim 1 comprising the eligibility service determining the type of product key based on information selected from a group consisting of where the customer is located, a type of channel the product/service was originally distributed through, a serial number attached to the product/service, a version of the product/service, and combinations thereof.

7. The method of claim 1 comprising the eligibility service determining the type of product key with reference to type mapping information available from a provider of the product/service.

8. The method of claim 1 comprising the portal redirecting the customer to a distributor as determined by one of the eligibility service, the portal, and the customer.

9. The method of claim 1 comprising the distributor delivering to the customer the identified type of product key by way of a member of a group consisting of a secure page, an encrypted electronic mail message, and a combination thereof.

10. The method of claim 1 comprising the distributor delivering the identified type of product key to a user interface of the product/service from which the delivered product key may be employed to activate such product/service.

11. The method of claim 1 further comprising:
the distributor reporting the delivered product key to a reporting service; and
the reporting service reporting to a product key distribution database that the product key has been delivered and reporting to an activation database that the delivered product key is available to activate the product/service,
whereby the customer may employ the delivered product key to activate the product/service by way of a product activation service, the activation database being updated by the product activation service upon such activation to reflect that the delivered product key has in fact been employed to activate the product/service.

12. A method of obtaining a refund of a purchased product key, the purchased product key for activating a digital product/service provided by a provider, the method comprising:
identifying the purchased product key to a blocking service;
the blocking service determining based on predetermined rules whether the provider authorizes the refund;
if the refund is authorized:
the blocking service submitting the product key to a product key distribution database to notify same that the product key is to be canceled;
the blocking service submitting the product key to an activation database to notify same that the product key is not available to activate the product/service, the activation database having knowledge of the submitted product key refusing to allow any future activation transaction based on such submitted product key.

13. The method of claim 12 further comprising:
a distributor receiving from a customer a request for the refund and an identification of the purchased product key, the customer coupled to the distributor by way of a network; and
the distributor determining based on predetermined business rules whether to accept the refund request from the customer;
the method comprising the distributor identifying the purchased product key to the blocking service if the refund request is accepted.

14. The method of claim 13 further comprising the distributor conducting a refund transaction with the customer if the blocking service authorizes the refund.

15. A system for providing a product key for activating a digital product/service, the system comprising:
a portal for obtaining information from a customer for the product key, the customer coupled to the portal by way of a network, the obtained information regarding the product/service for which the product key is required;
an eligibility service for receiving the obtained information from the portal, the eligibility service for determining whether the customer is eligible to obtain/purchase the product key; and, if the customer is eligible, for notifying the portal of same and for determining and identifying to the portal a type of product key to be provided to the customer;
a distributor to which the portal redirects the customer if such customer is eligible, the distributor being on the network, the redirection including the identified type of product key, the distributor for conducting an online transaction with the customer to provide the identified type of product key thereto.

16. The system of claim 15 wherein the portal obtains a previously submitted but invalid product key for the product or service, where the invalid product key includes therein information that may be employed to identify such product/service.

17. The system of claim 16 wherein the eligibility service determines by reference to a product key distribution database whether the invalid product key has previously resulted in more than a set number of additional product keys being distributed, and if so determines that the customer is not eligible.

18. The system of claim 15 wherein the portal obtains an ID of the product or service.

19. The system of claim 15 wherein the eligibility service determines whether the customer has a participating product/service.

20. The system of claim 15 wherein the eligibility service determines the type of product key based on information selected from a group consisting of where the customer is located, a type of channel the product/service was originally distributed through, a serial number attached to the product/service, a version of the product/service, and combinations thereof.

21. The system of claim 15 wherein the eligibility service determines the type of product key with reference to type mapping information available from a provider of the product/service.

22. The system of claim 15 wherein the portal redirects the customer to a distributor as determined by one of the eligibility service, the portal, and the customer.

23. The system of claim 15 wherein the distributor delivers to the customer the identified type of product key by way of a member of a group consisting of a secure page, an encrypted electronic mail message, and a combination thereof.

24. The system of claim 15 wherein the distributor delivers the identified type of product key to a user interface of the product/service from which the delivered product key may be employed to activate such product/service.

25. The system of claim 15 further comprising a reporting service to which the distributor reports the delivered product key, a product key distribution database for receiving a report from the reporting service that the product key has been delivered, and an activation database for receiving a report from the reporting service that the delivered product key is available to activate the product/service, whereby the customer may employ the delivered product key to activate the product/service by way of a product activation service, the activation database being updated by the product activation service upon such activation to reflect that the delivered product key has in fact been employed to activate the product/service.

26. A system for obtaining a refund of a purchased product key, the purchased product key for activating a digital product/service provided by a provider, the system comprising:
a blocking service to which the purchased product key is identified, the blocking service for determining based on predetermined rules whether the provider authorizes the refund;
a product key distribution database to which the blocking service submits the product key if the refund is authorized to notify same that the product key is to be canceled; and
an activation database to which the blocking service submits the product key if the refund is authorized to notify same that the product key is not available to activate the product/service, the activation database having knowledge of the submitted product key for refusing to allow any future activation transaction based on such submitted product key.

27. The system of claim 26 further comprising a distributor for receiving from a customer a request for the refund and an identification of the purchased product key, the customer coupled to the distributor by way of a network, the distributor determining based on predetermined business rules whether to accept the refund request from the customer, the distributor identifying the purchased product key to the blocking service if the refund request is accepted.

28. The system of claim 27 wherein the distributor conducts a refund transaction with the customer if the blocking service authorizes the refund.
